(19) United States
(12) Patent Application Publication
(10) Pub. No.: US 2020/0226498 A1
(43) Pub. Date: Jul. 16, 2020

(54) ALLOCATION OF VEHICLES TO PASSENGERS USING ROUTE PREFERENCES

(71) Applicant: ANI TECHNOLOGIES PRIVATE LIMITED, Bengaluru (IN)

(72) Inventors: Moiaz Jiwani, Bilaspur (IN); Azimul Mannan, Bengaluru (IN)

(73) Assignee: ANI TECHNOLOGIES PRIVATE LIMITED, Bengaluru (IN)

(21) Appl. No.: 16/535,572

(22) Filed: Aug. 8, 2019

(30) Foreign Application Priority Data
Jan. 11, 2019 (IN) 201941001463

(51) Int. Cl. G06Q 10/02; G06Q 50/30; G06Q 10/06; G08G 1/00

(52) U.S. Cl. CPC G06Q 10/02; G08G 1/202; G06Q 10/06315; G06Q 50/30

(57) ABSTRACT

Allocation of a vehicle to a passenger includes receiving a booking request for a share-ride or a non-share ride. Based on the booking request, sets of sponsored and non-sponsored routes are identified. Each identified route connects at least a source location and a destination location associated with the booking request. Further, one or more sponsored routes are selected from the set of sponsored routes based on a persona of the passenger. A sponsored or non-sponsored route is selected, by the passenger, from the one or more sponsored routes or the set of non-sponsored routes, respectively. Based on the selection by the passenger, an available vehicle is allocated to the passenger for the ride. Similarly, at least sponsored routes are identified and presented to a driver of the allocated vehicle for travelling from a current location to the source location of the passenger.

### CROSS-RELATED APPLICATIONS

This application claims priority of Indian Application Serial No. 201941001463, filed Jan. 11, 2019, the contents of which are incorporated herein by reference.

### FIELD

Various embodiments of the disclosure relate generally to vehicle allocation systems. More specifically, various embodiments of the disclosure relate to allocation of vehicles to passengers using route preferences.

### BACKGROUND

With the advancement in communication technologies and easier accessibility to mobile computing devices, the popularity for on-demand cab services is continuously increasing. Also, with the improvement in lifestyles of the individuals and the need for extra comfort, the individuals prefer the on-demand cab services for commuting to and from their work places, or when the individuals are engaged in personal activities such as outstation travels. In modern cities, vehicle service providers play an important role by offering the on-demand cab services to the individuals to travel to desired destinations. Generally, a vehicle service provider, for example, a cab service provider (such as OLA) is engaged in facilitating an online platform for offering the on-demand cab services to the individuals. The cab service provider deploys a set of cabs (e.g., cars) in a geographical region to meet demand from the individuals.

The cab service provider regularly endeavors to provide enhanced ride experiences to the individuals with saving of time and money. With increased competition, a majority of cab service providers are operating with narrow profit margins, or even with losses. Any cab service provider can efficiently operate in the geographical region only when there is sufficient demand that can meet the available supply facilitated by the cab service provider. To keep the loyalty of the individuals (such as drivers and/or passengers), the cab service provider associates rides with various offers for the individuals, which help in increasing the demand. However, with such offers, the overall revenue is reduced, which further decreases the overall operating cost that may not be desirable for any cab service provider. Share rides were introduced to have optimal utilization of the vehicles that facilitated reduced fare for each individual but at the cost of ride time. Also, not all individuals prefer ride-sharing, and hence ride-sharing approach also resulted in limited profit margins. The existing cab service providers aim only to offer the cab services to the individuals in a way that may minimize the ride fare, the transit time, or the transit distance. The cab service providers focus less on enhancing the travel experience or making the ride more interesting in a way that can help maximize the demand for the cab services.

In light of the foregoing, there exists a need for a technical and reliable solution that overcomes the above-mentioned problems, challenges, and short-comings, and continues to facilitate on-demand cab services to individuals that may improve the overall travel experiences of the individuals. Further, the solution should facilitate reduced fares to the individuals that may help to enhance and maximize the demand for the cab services without compromising on the overall revenue and operating cost.

### SUMMARY

Allocation of vehicles to passengers using route preferences is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an environment for vehicle allocation, in accordance with an exemplary embodiment of the disclosure;

FIG. 2 is a block diagram that illustrates a transportation server of the environment of FIG. 1, in accordance with an exemplary embodiment of the disclosure;

FIG. 3 is a block diagram that illustrates a road map of a geographical region including sponsored and non-sponsored routes, in accordance with an exemplary embodiment of the disclosure;

FIG. 4 is a block diagram that illustrates a user interface rendered on a passenger device of the environment of FIG. 1, in accordance with an exemplary embodiment of the disclosure;

FIG. 5 is a block diagram that illustrates a user interface rendered on a passenger device of the environment of FIG. 1, in accordance with an exemplary embodiment of the disclosure;

FIG. 6 is a block diagram that illustrates a user interface rendered on a driver device of the environment of FIG. 1, in accordance with an exemplary embodiment of the disclosure;

FIG. 7 is a block diagram that illustrates a user interface rendered on a passenger device, in accordance with another exemplary embodiment of the disclosure;

FIG. 8 is a flow chart that illustrates a method for allocating a vehicle to a passenger for a non-share ride, in accordance with an exemplary embodiment of the disclosure;

FIG. 9 is a flow chart that illustrates a method for allocating a vehicle to a passenger for a share-ride, in accordance with an exemplary embodiment of the disclosure;

FIG. 10 is a flow chart that illustrates a method for detouring an ongoing ride, in accordance with an exemplary embodiment of the disclosure; and

FIG. 11 is a block diagram that illustrates a system architecture of a computer system for allocating vehicles to passengers, in accordance with an exemplary embodiment of the disclosure.

### DETAILED DESCRIPTION

Certain embodiments of the disclosure may be found in a disclosed apparatus for vehicle allocation. Exemplary aspects of the disclosure provide a method and a system for allocating a vehicle to one or more passengers by utilizing route preferences of the one or more passengers. The method includes one or more operations that are executed by circuitry of a transportation server to allocate the vehicle to the one or more passengers. The circuitry may be configured to receive a booking request for a ride from a first passenger device via a communication network. The booking request may include at least a source location and a destination location for the requested ride. The circuitry may be configured to identify a first set of sponsored routes and a first set of non-sponsored routes from all possible routes that are connecting at least the source location with the destination location. Each sponsored route in the first set of sponsored routes may be associated with at least one of a static advertisement, a dynamic advertisement, or a business establishment associated with one or more sponsors. Each sponsored route may be further associated with at least one offer that is offered by the one or more sponsors. The offer may correspond to at least one of a flat discount, a distance-based discount, a reward point, or a free ride offer. Each non-sponsored route in the first set of non-sponsored routes may be independent of any offer.

In an embodiment, the circuitry may be configured to select one or more sponsored routes from the first set of sponsored routes based on a persona of a first passenger. The circuitry may be configured to generate the persona of the first passenger based on at least one of historical travel data, a social media profile, in-vehicle activities during historical rides, or one or more preferences of the first passenger. Upon selection of the one or more sponsored routes, the circuitry may be configured to determine a ride fare for the ride along each sponsored route and each non-sponsored route. The ride fare may be determined based on at least one of a distance, a cost per unit distance factor, or a flat fare factor. The ride fare for the ride along each sponsored route may be further determined based on a corresponding offer (associated with each sponsored route) that is offered by the one or more sponsors.

In an embodiment, the circuitry may be configured to render a first user interface on the first passenger device. The first user interface may present the one or more sponsored routes and the first set of non-sponsored routes as one or more selectable options to the first passenger. The first user interface may also include the ride fare associated with each sponsored route and each non-sponsored route. The first user interface may be utilized, by the first passenger, to select one of a first sponsored route or a first non-sponsored route from the one or more sponsored routes and the first set of non-sponsored routes for the ride. Further, the circuitry may be configured to allocate an available vehicle to the first passenger for the ride based on selection of a route (e.g., the first sponsored route or the first non-sponsored route) by the first passenger. The available vehicle may be one of a shared vehicle or a non-shared vehicle. In an embodiment, the circuitry may be further configured to communicate at least one of the persona, the one or more preferences, or real-time location of the first passenger to the one or more sponsors associated with the first sponsored route, based on selection of the first sponsored route by the first passenger for the ride.

In an embodiment, the circuitry may be configured to generate a persona of a driver of the available vehicle based on at least one of historical travel data, a social media profile, in-vehicle activities during historical rides, or one or more preferences of the driver. The circuitry may be further configured to determine a second set of sponsored routes for the driver based on at least the persona of the driver. Each sponsored route in the second set of sponsored routes may originate from a first location and terminate at the source location, and the available vehicle may be currently located at the first location when the available vehicle is allocated to the first passenger. Further, the circuitry may be configured to render a second user interface on a driver device of the driver. The second user interface may present at least the second set of sponsored routes as one or more selectable options to the driver. The driver may be incentivized by one or more sponsors associated with a second sponsored route of the second set of sponsored routes, based on selection of the second sponsored route by the driver to reach the source location from the first location.

In an embodiment, the circuitry may be configured to communicate information pertaining to the first sponsored route, selected by the first passenger, to at least one second passenger travelling in the shared vehicle, when the booking request is for ride-sharing. The information may be communicated before allocation of the shared vehicle to the first passenger. The circuitry may communicate the information to the second passenger when a degree of compatibility between a persona of the second passenger and the first sponsored route exceeds a threshold score. Further, the circuitry may be configured to allocate the shared vehicle to the first passenger, when a consent for travelling along the first sponsored route may be provided the second passenger.

In an embodiment, the circuitry may be configured to render a third user interface on the first passenger device, when the first passenger is already travelling along the first non-sponsored route. The third user interface may present a re-route option to the first passenger, when a part of a route associated with the re-route option is sponsored by one or more sponsors. The first passenger may be incentivized by the one or more sponsors in real time, based on selection of the re-route option by the first passenger to reach the destination location.

Thus, various methods and systems of the disclosure provide allocation of one or more available vehicles to one or more passengers. The disclosed vehicle allocation methods and systems may facilitate an alternative source for incentivizing a ride based on various offers associated with each sponsored route sponsored by one or more sponsors. Further, incentivization of rides may help in optimizing (i.e., reducing) ride fares for the rides that may be availed by the one or more passengers. Also, the one or more passengers may have the flexibility to choose between sponsored and non-sponsored routes for shared or non-shared rides as per their conveniences. Such flexibility is also offered to each driver to choose between sponsored and non-sponsored routes. When one or more drivers and passengers are travelling via a sponsored route, the one or more sponsors of the sponsored route may present or display targeted content to the one or more drivers and passengers. The targeted content may be presented or displayed on dynamic or static signage boards. Such presentation or display of the targeted content may help the one or more sponsors to enhance businesses or other establishments along the sponsored route by attracting more and more potential customers in the form of at least the one or more drivers and passengers. Also, various transport service providers (e.g., a cab service provider such as OLA) may enjoy and appreciate an alternative source of income that can boost the overall revenue for the transport service providers. Thus, the transport service providers can continue to provide attractive offers and incentives to the one or more passengers and drivers without compromising on the overall in-vehicle experiences, which may help to maximize bookings for one-demand cab services in an online manner.

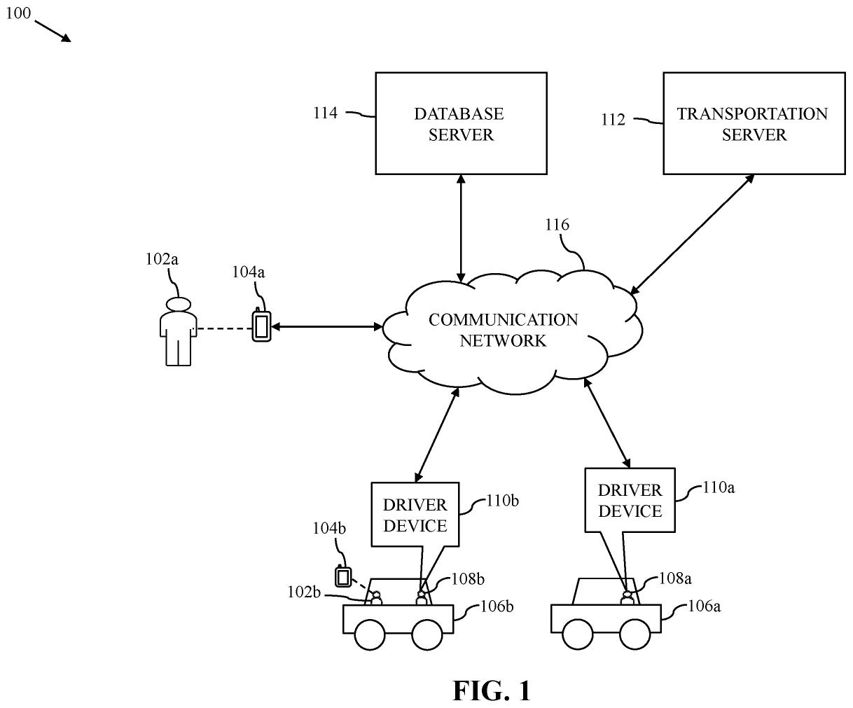

FIG. 1 is a block diagram that illustrates an environment 100 for vehicle allocation, in accordance with an exemplary embodiment of the disclosure. The environment 100 includes passengers 102a and 102b, passenger devices 104a and 104b, vehicles 106a and 106b, drivers 108a and 108b, driver devices 110a and 110b, a transportation server 112, and a database server 114. The passenger devices 104a and 104b, the driver devices 110a and 110b, the transportation server 112, and the database server 114 are connected to each other via a communication network 116.

The passengers 102a and 102b are individuals who may want to travel from one location to one or more other locations by availing on-demand vehicle or ride services offered by a vehicle service provider (e.g., a cab service provider such as OLA). The on-demand vehicle or ride services may be availed, by the passengers 102a and 102b, by initiating online booking requests. The online booking requests may be initiated, by the passengers 102a and 102b, by utilizing computing devices such as the passenger devices 104a and 104b, respectively.

Each of the passenger devices 104a and 104b may include suitable logic, circuitry, interfaces, and/or code, executable by the circuitry, that may be configured to perform one or more operations. For example, the passenger device 104a may be a computing device that is utilized, by the passenger 102a, to initiate the one or more operations by utilizing a service application (associated with the vehicle service provider and hosted by the transportation server 112) running on the passenger device 104a. For example, the passenger device 104a may be utilized, by the passenger 102a, to schedule a ride. To schedule the ride, a booking request may be initiated, by the passenger 102a, by utilizing the service application running on the passenger device 104a. The booking request may include at least a source location and a destination location for the ride that are inputted by the passenger 102a. The booking request may further include other information, for example, a ride type, a vehicle type, a pick-up time, or other service-related details and preferences. Various modes of input that may be utilized by the passenger 102a to initiate the booking request include, but are not limited to, a touch-based input, a text-based input, a voice-based input, a gesture-based input, or a combination thereof. Further, upon confirmation of the booking request for the ride by the passenger 102a, the passenger device 104a may be configured to transmit the booking request to the transportation server 112 via the communication network 116. In another embodiment, the service application (running on the passenger device 104a) may be configured to transmit the booking request to the transportation server 112 via the communication network 116.

In an embodiment, the passenger device 104a may be configured to receive, from the transportation server 112 via the communication network 116, one or more user interfaces that allow the passenger 102a to interact with one or more computing devices, servers, or applications for performing the one or more operations. The one or more user interfaces may be received in response to the booking request initiated by the passenger 102a. Further, the passenger device 104a may be utilized, by the passenger 102a, to view the one or more user interfaces (one at a time) rendered by the transportation server 112. The passenger 102a may interact with each user interface to provide one or more inputs for initiating the one or more operations associated with the booking request. For example, the passenger device 104a may be utilized, by the passenger 102a, to provide an input to select a route from one or more routes. The one or more routes may or mayn't be sponsored by one or more sponsors. Further, the one or more routes may or mayn't include a static advertisement, a dynamic advertisement, or a business establishment. In another example, the passenger device 104a may be utilized, by the passenger 102a, to provide an input to confirm or reject vehicle allocation offered by the transportation server 112.

In an embodiment, the passenger device 104a may be configured to receive allocation information from the transportation server 112 based on allocation of an available vehicle, such as the vehicle 106a, to the passenger 102a. The passenger device 104a may be further utilized, by the passenger 102a, to view the allocation information including at least one of driver information, vehicle information, route allocation information, or ride fare information. Further, in an embodiment, the passenger device 104a may be utilized, by the passenger 102a during an ongoing ride, to provide an input to accept or decline detouring of the ongoing ride offered by the transportation server 112.

Various functionalities and operations of the passenger device 104b may be similar to functionalities and operations of the passenger device 104a as described above. Examples of the passenger device 104a or 104b include, but are not limited to, a personal computer, a laptop, a smartphone, and a tablet computer.

The vehicles 106a and 106b are means of transport that are deployed by the vehicle service provider to offer the on-demand vehicle or ride services to one or more passengers such as the passengers 102a and 102b. Examples of the vehicle 106a or 106b include, but are not limited to, an automobile, a bus, a car, and a bike. In an embodiment, the vehicle 106a or 106b may be associated with one of various vehicle categories associated with the vehicle service provider for offering the on-demand vehicle or ride services to the passengers 102a and 102b. In one example, the vehicle 106a or 106b is a micro-category vehicle (e.g., a compact hatchback vehicle). In another example, the vehicle 106a or 106b is a mini-category vehicle (e.g., a regular hatchback vehicle). In another example, the vehicle 106a or 106b is a prime-category vehicle (e.g., a prime sedan vehicle, a prime play vehicle, a prime sport utility vehicle (SUV), or a prime executive vehicle). In another example, the vehicle 106a or 106b is a lux-category vehicle (e.g., a luxury vehicle). In an embodiment, the vehicle service provider may deploy the vehicles 106a and 106b for offering different types of rides, such as share-rides, non-share rides, rental rides, or the like, to the one or more passengers such as the passengers 102a and 102b. For example, the vehicle 106a may be utilized for offering a non-share ride service, i.e., the vehicle 106a may be allocated to only one passenger for travelling between locations on individual-basis, and the vehicle 106b may be utilized for offering a share-ride service, i.e., the vehicle 106b may be allocated to the one or more passengers for travelling between locations on shared-basis.

The drivers 108a and 108b are individuals who drive the vehicles 106a and 106b, respectively, in a geographical region (or across geographical regions) for offering the on-demand vehicle or ride services to the one or more passengers. Computing devices (such as the driver devices 110a and 110b) may be utilized by the drivers (such as the drivers 108a and 108b) for connecting to an online platform (e.g., the transportation server 112) via the communication network 116 and receiving the allocation information in an online manner for offering the on-demand vehicle or ride services to the one or more passengers.

Each of the driver devices 110a and 110b may include suitable logic, circuitry, interfaces, and/or code, executable by the circuitry, that may be configured to perform one or more operations. For example, the driver device 110a may be a computing device that is utilized, by the driver 108a, to initiate the one or more operations by utilizing a service application (associated with the vehicle service provider and hosted by the transportation server 112) running on the driver device 110a. For example, the driver device 110a may be utilized, by the driver 108a, to receive and view a new ride request (e.g., a non-share ride request) by utilizing the service application running on the driver device 110a, and accept or reject the new ride request. The driver device 110a may be further utilized, by the driver 108a, to view and follow directions along a route by utilizing a digital map hosted by the transportation server 112 on the driver device 110a. In an embodiment, the driver device 110a (or the service application running on the driver device 110a) may be configured to transmit information, such as an availability status, a current booking status, a ride completion status, a pick-up time, a drop-off time, a collected ride fare, real-time position information, or the like, to the transportation server 112 via the communication network 116.

In an embodiment, the driver device 110a may be utilized, by the driver 108a, to view one or more user interfaces (one at a time) rendered by the transportation server 112. The driver 108a may interact with the one or more user interfaces to provide one or more inputs for initiating the one or more operations associated with the new booking request. For example, the driver device 110a may be utilized, by the driver 108a, to provide an input to accept or reject the new booking request. The driver device 110a may be utilized, by the driver 108a, to provide an input to select a route from one or more routes. The one or more routes may or mayn't be sponsored by one or more sponsors. Further, the one or more routes may or mayn't include a static advertisement, a dynamic advertisement, or a business establishment. Further, the driver device 110a may be utilized, by the driver 108a, to navigate between locations by utilizing the digital map rendered on the driver device 110a by the transportation server 112. For example, upon acceptance of the new booking request such as the booking request initiated by the passenger 102a, the digital map may be utilized, by the driver 108a, to select a preferred route from the one or more routes (suggested or offered by the transportation server 112) to reach the source location (i.e., a pick-up location) of the passenger 102a from a current location of the vehicle 106a. Thereafter, the digital map may be utilized, by the driver 108a, to navigate from the current location to the source location by driving the vehicle 106a. Further, after picking-up the passenger 102a from the source location, the digital map may be utilized, by the driver 108a, to navigate from the source location to the destination location (i.e., a drop-off location) by driving the vehicle 106a. In an embodiment, the digital map may be dynamically updated, by the transportation server 112, based on a route (e.g., a sponsored or non-sponsored route) selected by the passenger 102a before or after boarding the vehicle 106a for the ride.

Various functionalities and operations of the driver device 110b may be similar to functionalities and operations of the driver device 110a as described above. In an exemplary embodiment, the driver device 110a or 110b may be a vehicle head unit. In another exemplary embodiment, the driver device 110a or 110b may be an external communication device, such as a smartphone, a tablet computer, a laptop, or any other portable communication device, that is placed inside the vehicle 106a or 106b, respectively.

The transportation server 112 may include suitable logic, circuitry, interfaces, and/or code, executable by the circuitry, that may be configured to perform one or more operations for vehicle allocation using route preferences. The transportation server 112 may be a computing device, which may include a software framework, that may be configured to create the transportation server implementation and perform the various operations associated with the vehicle allocation. The transportation server 112 may be realized through various web-based technologies, such as, but are not limited to, a Java web-framework, a .NET framework, a PHP framework, a python framework, or any other web-application framework. Examples of the transportation server 112 include, but are not limited to, a personal computer, a laptop, or a network of computer systems.

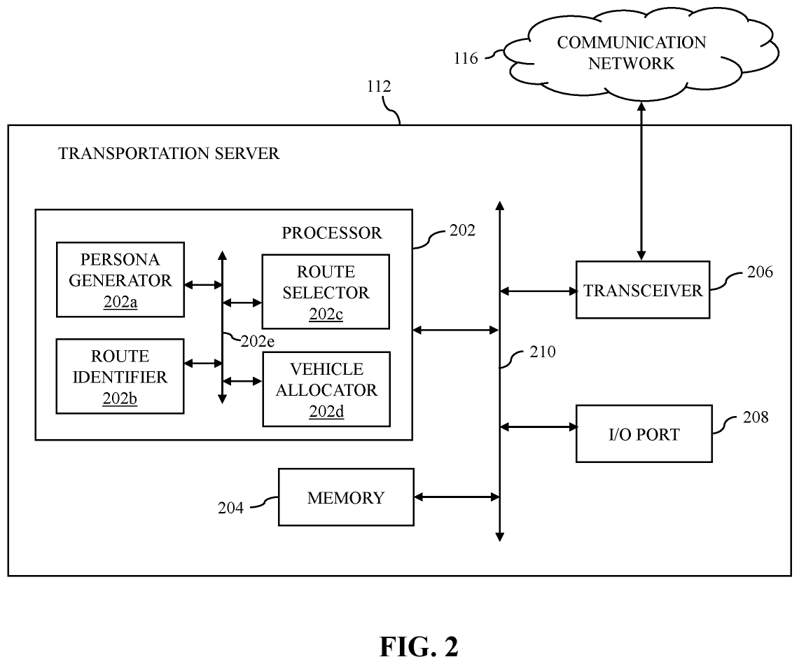

In an embodiment, the transportation server 112 may be configured to process, control, and manage various functionalities and operations such as booking request reception, persona generation, route identification, route selection, fare determination, and vehicle allocation. For example, the transportation server 112 may be configured to receive one or more booking requests such as the booking request (initiated by the passenger 102a for the ride) from the passenger device 104a via the communication network 116. Based on the received booking request, the transportation server 112 may be configured to identify a first set of sponsored routes and a first set of non-sponsored routes for the ride. The transportation server 112 may be configured to generate a persona of the passenger 102a. Further, the transportation server 112 may be configured to select one or more sponsored routes from the first set of sponsored routes based on the generated persona of the passenger 102a. The transportation server 112 may be further configured to determine a ride fare for the ride associated with each selected sponsored route and each non-sponsored route. In an embodiment, the transportation server 112 may be further configured to generate and render the one or more user interfaces on the passenger device 104a via the service application running on the passenger device 104a. For example, the transportation server 112 may render a first user interface on the passenger device 104a via the communication network 116. The first user interface may present the one or more sponsored routes and the first set of non-sponsored routes. The first user interface further present the ride fare associated with each route. Based on selection of a route from the one or more sponsored routes and the first set of non-sponsored routes by the passenger 102a, the transportation server 112 may be further configured to allocate the available vehicle, such as the vehicle 106a, to the passenger 102a for the ride. The transportation server 112 may allocate the vehicle 106a to the passenger 102a based on a consent provided by the driver 108a of the vehicle 106a for the ride. The transportation server 112 may be configured to process other services and requests associated with the booking request initiated by the passenger 102a or allocation of the vehicle 106a to the passenger 102a, and accordingly, may control, modify, and execute the other services and requests prior to the start of the ride or during the ride. Various operations and functionalities of the transportation server 112 have been described in detail in conjunction with FIGS. 2-10.

The database server 114 may include suitable logic, circuitry, interfaces, and/or code, executable by the circuitry, that may be configured to perform one or more operations, such as receiving, storing, processing, and transmitting queries, data, or content. The database server 114 may be a data management and storage computing device that is communicatively coupled to the passenger devices 104a and 104b, the driver devices 110a and 110b, and the transportation server 112 via the communication network 116 to perform the one or more operations. In an exemplary embodiment, the database server 114 may be configured to manage and store historical travel data of various passengers such as the passengers 102a and 102b. The historical travel data of each passenger (such as the passenger 102a or 102b) may include travel data of rides (e.g., share-rides or non-share rides) availed by each passenger in the past using various vehicles, such as the vehicle 106a or 106b, offered by the cab service provider. In an exemplary embodiment, the historical travel data of each passenger may include at least historical pick-up and drop-off locations, a frequency of historical rides between various pick-up and drop-off locations, or a pick-up and drop-off time of each historical ride that had been availed by the passenger 102a in the past. The historical travel data may further include historical preferences of each passenger. For example, the historical preferences may be indicative of one or more categories of vehicles and one or more types of routes preferred by each passenger. The database server 114 may be configured to receive the historical travel data of the passengers (such as the passengers 102a and 102b) from the driver devices (such as the driver devices 110a and 110b), the passenger devices (such as the passenger devices 104a and 104b), or the transportation server 112.

The database server 114 may be further configured to manage and store passenger information of each passenger (such as the passenger 102a or 102b) and driver information of each driver (such as the driver 108a or 108b). The passenger information of each passenger may include at least a passenger name, a passenger contact number, or a passenger account registered with the cab service provider. The passenger information of each passenger may further include a social media profile, in-vehicle activities associated with the historical rides, a passenger device type, and a payment mode. The social media profile may indicate personal information and hobbies of each passenger along with likes or dislikes of each passenger for one or more entities, products, services, books, multimedia content, or the like. The in-vehicle activities of each passenger may indicate passenger behavior, language preferences, music preferences, seat preferences, content preferences, or the like. Similarly, the driver information of each driver may include at least a driver name, a registered vehicle make, a vehicle type, or a driver account registered with the cab service provider. The driver information of each driver may further include a social media profile, in-vehicle activities associated with the historical rides, and a driver device type.

In an embodiment, the database server 114 may be configured to generate a data structure including one or more rows and columns for storing the information of each passenger (or each driver) in a structured manner. For example, each row may be associated with a unique passenger identifier (ID) of each passenger, and one or more columns corresponding to each row may indicate the passenger name, the passenger ID, the historical pick-up and drop-off locations, the frequency of historical rides between various historical pick-up and drop-off locations, the pick-up and drop-off time of each historical ride, and/or the passenger preferences. In an embodiment, the database server 114 may be configured to store the allocation information (i.e., information indicating the current availability status) of each vehicle (such as the vehicle 106a or 106b) associated with the cab service provider. The allocation information of each vehicle may be dynamically updated in real-time by the transportation server 112 based on the current allocation status of each vehicle. The current allocation status of each vehicle may indicate whether each vehicle is available for new allocation or not corresponding to the new booking request.

In an embodiment, the database server 114 may be configured to receive a query from the transportation server 112 via the communication network 116. The query may correspond to an encrypted message that is decoded by the database server 114 to determine a request for retrieving requisite information (such as the vehicle information, the driver information, the passenger information, the allocation information, or any combination thereof). In response to the determined request, the database server 114 may be configured to retrieve and communicate the requested information to the transportation server 112 via the communication network 116. Examples of the database server 114 may include, but are not limited to, a personal computer, a laptop, or a network of computer systems.

The communication network 116 may include suitable logic, circuitry, interfaces, and/or code, executable by the circuitry, that may be configured to transmit queries, messages, and requests between various entities, such as the passenger devices 104a and 104b, the driver devices 110a and 110b, the transportation server 112, and/or the database server 114. Examples of the communication network 116 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the environment 100 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the transportation server 112 may be configured to receive the booking request from the passenger device 104a for the ride between the source location and the destination location. Based on the booking request, the transportation server 112 may be configured to identify routes that are connecting the source location and the destination location. The identified routes may include at least one of the first set of sponsored routes and the first set of non-sponsored routes. In an embodiment, a sponsored route is a route sponsored by one or more sponsors (e.g., an individual, a company, a business entity, or the like). The one or more sponsors may provide one or more offers to the one or more passengers or drivers for riding or travelling via the sponsored route. The one or more sponsors may also provide one or more offers to the cab service provider who is offering on-demand vehicle services to the one or more passengers via the sponsored route. The sponsored route may be associated with at least one of a static advertisement, a dynamic advertisement, or a business establishment associated with the one or more sponsors.

In an embodiment, a non-sponsored route is a route that is not sponsored by one or more sponsors and is independent of any offer. The non-sponsored route may or mayn't be associated with a static advertisement, a dynamic advertisement, or a business establishment. In an embodiment, an offer is a reward in terms of a monetary benefit, a voucher, or a subscription to a loyalty program that is offered by the one or more sponsors to the one or more passengers or drivers, when the one or more passengers or drivers agree to travel via the sponsored route, or to the cab service provider for offering the on-demand vehicle services to the one or more passengers through the sponsored route.

In an embodiment, the transportation server 112 may be configured to generate the persona of the passenger 102a. The persona of the passenger 102a may be generated based on at least one of the historical travel data, the social media profile, the in-vehicle activities during historical rides, or the one or more preferences of the passenger 102a. In another embodiment, the transportation server 112 may be configured to retrieve the persona of the passenger 102a from the database server 114. The persona may be a fictional character that characterizes key traits of a particular group of audiences, for example, the passenger 102a. The key traits may include things like motivations, needs, technical skills, jobs, likes, dislikes, hobbies, and other factors that may impact how the passenger 102a interacts with any of marketing campaigns or advertisements.

In an embodiment, the transportation server 112 may be configured to select the one or more sponsored routes from the first set of sponsored routes based on the persona of the passenger 102a. Upon selection of the one or more sponsored routes, the transportation server 112 may be configured to determine the ride fare for the ride (requested by the passenger 102a) along each sponsored route (of the one or more sponsored routes) and each non-sponsored route (of the first set of non-sponsored routes). The ride fare may be determined based on at least a ride distance, a ride time, a cost per unit distance, a cost per unit time, a flat fare factor, a vehicle type, real-time demand and supply, or any combination thereof. The ride fare for each sponsored route may be further determined based on the corresponding offer.

In an embodiment, the transportation server 112 may be configured to generate and render the first user interface on the passenger device 104a for presenting the one or more sponsored routes and the first set of non-sponsored routes. The one or more sponsored routes and the first set of non-sponsored routes may be presented on a digital map (hosted by the transportation server 112) that is included in the first user interface. The one or more sponsored routes and the first set of non-sponsored routes may be presented as selectable options to the passenger 102a along with the corresponding ride fare. The first user interface rendered on the passenger device 104a may be utilized, by the passenger 102a, to select a route from the one or more sponsored routes and the first set of non-sponsored routes. In one example, a first sponsored route may be selected, by the passenger 102a, from the one or more sponsored routes and the first set of non-sponsored routes. In another example, a first non-sponsored route may be selected, by the passenger 102a, from the one or more sponsored routes and the first set of non-sponsored routes. After receiving the route selection from the passenger device 104a, the transportation server 112 may be configured to allocate the available vehicle, for example, the vehicle 106a to the passenger 102a for the ride based on the selected route. In one example, the transportation server 112 may allocate the vehicle 106a to the passenger 102a based on the first sponsored route selected by the passenger 102a. In another example, the transportation server 112 may allocate the vehicle 106a to the passenger 102a based on the first non-sponsored route selected by the passenger 102a. Based on the selection of first sponsored route by the passenger 102a and the corresponding allocation of the vehicle 106a to the passenger 102a, the transportation server 112 may be configured to communicate at least one of the persona, preferences, or real-time location of the passenger 102a to the one or more sponsors associated with the first sponsored route.

Upon allocation of the vehicle 106a to the passenger 102a, the transportation server 112 may be configured to identify routes that are connecting a vehicle location of the vehicle 106a with the source location of the passenger 102a. The vehicle location may be the current location of the vehicle 106a when the transportation server 112 allocated the vehicle 106a to the passenger 102a. In an embodiment, the transportation server 112 may be further configured to select at least a second set of sponsored routes from the routes based on a persona of the driver 108a of the vehicle 106a. In an embodiment, the transportation server 112 may be configured to generate the persona of the driver 108a in real-time. The persona of the driver 108a may be generated based on at least one of the historical travel data, the social media profile, the in-vehicle activities during historical rides, or the one or more preferences of the driver 108a. In another embodiment, the transportation server 112 may be configured to retrieve the persona of the driver 108a from the database server 114. Upon selection of at least the second set of sponsored routes, the transportation server 112 may be configured to generate and render a second user interface on the driver device 110a of the driver 108a. The second set of sponsored routes may be presented on a digital map (hosted by the transportation server 112) that is included in the second user interface. The second set of sponsored routes may be presented as selectable options to the driver 108a. The driver 108a may be incentivized by one or more sponsors associated with a second sponsored route of the second set of sponsored routes, based on selection of the second sponsored route by the driver 108a to reach the source location from the vehicle location. Each sponsored route in the second sets of sponsored routes may be associated with at least one of a static advertisement, a dynamic advertisement, or a business establishment associated with the one or more sponsors.

Further, in an embodiment, when the booking request is for ride-sharing, the transportation server 112 may be configured to communicate preference information pertaining to the first sponsored route, selected by the passenger 102a, to at least the passenger 102b who may be already travelling in a ride-sharing vehicle such as the vehicle 106b. The preference information may be communicated before allocation of the vehicle 106b to the passenger 102a. The transportation server 112 may be configured to communicate the preference information to the passenger 102b when a degree of compatibility between a persona of the passenger 102b and the first sponsored route exceeds a threshold score. The transportation server 112 may be further configured to allocate the vehicle 106b to the passenger 102a when the passenger 102b provides a consent for travelling along the first sponsored route.

Further, in an embodiment, when the passenger 102a may be already travelling along a non-sponsored route (for example, the first non-sponsored route), the transportation server 112 may be configured to generate and render, on the passenger device 104a, a third user interface presenting a re-route option to the passenger 102a. In an embodiment, the re-route option may be associated with a route (e.g., a sponsored route) and a part of the route may be sponsored by one or more sponsors. The ongoing ride of the passenger 102a may be incentivized by the one or more sponsors in real time, based on selection of the re-route option by the passenger 102a to reach the destination location. Various other functionalities and operations of the transportation server 112 have been described in detail in conjunction with FIGS. 2-11.

FIG. 2 is a block diagram that illustrates the transportation server 112, in accordance with an exemplary embodiment of the disclosure. The transportation server 112 includes circuitry such as a processor 202, a memory 204, a transceiver 206, and an input/output (I/O) port 208 that communicate with each other by way of a first communication bus 210.

The processor 202 may include suitable logic, circuitry, interfaces, and/or codes, executable by the circuitry, that may be configured to perform the one or more operations for the vehicle allocation using the route preferences. For example, the processor 202 may be configured to control and manage various functionalities and operations such as persona generation, route identification, route selection, fare determination, and vehicle allocation. The various functionalities and operations may be controlled and managed by one or more internal components of the processor 202, such as a persona generator 202a, a route identifier 202b, a route selector 202c, and a vehicle allocator 202d, that communicate with each other by way of a second communication bus 202e.

In an embodiment, the processor 202 may operate as a master processing unit, and the persona generator 202a, the route identifier 202b, the route selector 202c, and the vehicle allocator 202d may operate as slave processing units. In such a scenario, the processor 202 may be configured to instruct the persona generator 202a, the route identifier 202b, the route selector 202c, and the vehicle allocator 202d to perform their corresponding operations either independently or in conjunction with each other. Examples of the processor 202 include, but are not limited to, an application-specific integrated circuit (ASIC) processor, a reduced instruction set computing (RISC) processor, a complex instruction set computing (CISC) processor, and a field-programmable gate array (FPGA). It will be apparent to a person skilled in the art that the processor 202 may be compatible with multiple operating systems.

The persona generator 202a may include suitable logic, circuitry, interfaces, and/or codes, executable by the circuitry, that may be configured to perform the one or more operations for generating persona of the one or more passengers and drivers. For example, the persona generator 202a may be configured to extract the historical travel data of the passenger 102a from the database server 114 and store the extracted historical travel data in the memory 204. The persona generator 202a may be further configured to extract the passenger information of the passenger 102a from the database server 114 and store the extracted passenger information in the memory 204. The persona generator 202a may be configured to process the passenger information (such as personal information, social media profile, in-vehicle activities, or the like) and/or the historical travel data (such as preferred source or destination stops, preferred vehicle or route types, or the like) to generate the persona of the passenger 102a. In an embodiment, the persona of the passenger 102a may be generated in real-time when the booking request is initiated by the passenger 102a. In another embodiment, the persona of the passenger 102a may be generated well in advance (for example, at the time of registration of the passenger 102a with the cab service provider) and may be stored in the database server 114. Further, in an embodiment, the persona generator 202a may be configured to update the persona of the passenger 102a after completion of each ride.

Further, the persona generator 202a may be configured to generate personas for other passengers (such as the passenger 102b) or the drivers (such as the drivers 108a and 108b) in a manner similar to generation of the persona for the passenger 102a. The persona generator 202a may be realized by utilizing one or more mathematical models, statistical models, and/or algorithms. The persona generator 202a may be implemented by one or more processors, such as, but are not limited to, an ASIC processor, a RISC processor, a CISC processor, and an FPGA.

The route identifier 202b may include suitable logic, circuitry, interfaces, and/or codes, executable by the circuitry, that may be configured to perform the one or more operations for identifying one or more routes including at least one of sponsored or non-sponsored routes. For example, the route identifier 202b may be configured to process the booking request initiated by the passenger 102a and identify the first set of sponsored routes and the first set of non-sponsored routes that are connecting at least the source location with the destination location. Each sponsored route in the first set of sponsored routes may originate at least from the source location and terminate at least at the destination location, and may be associated with at least one offer provided by the one or more sponsors. Each non-sponsored route in the first set of non-sponsored routes may originate at least from the source location and terminate at least at the destination location, and may be independent of any offer. Further, upon allocation of the vehicle 106a to the passenger 102a, the route identifier 202b may be configured to identify the second set of sponsored routes that are connecting at least the vehicle location of the vehicle 106a with the source location of the passenger 102a. The route identifier 202b may be configured to communicate the identified routes (such as the first set of non-sponsored routes and the first and second sets of sponsored routes) to the route selector 202c via the second communication bus 202e. The route identifier 202b may be realized by utilizing one or more mathematical models, statistical models, and/or algorithms. The route identifier 202b may be implemented by one or more processors, such as, but are not limited to, an ASIC processor, a RISC processor, a CISC processor, and an FPGA.

The route selector 202c may include suitable logic, circuitry, interfaces, and/or codes, executable by the circuitry, that may be configured to perform the one or more operations for selecting the route preferences for vehicle allocation. For example, the route selector 202c may be configured to determine the route preferences of each passenger, and store the route preferences in the memory 204. The route preferences of each passenger, for example, the passenger 102a may be determined based on at least the persona of the passenger 102a. The route selector 202c may be configured to obtain the first set of sponsored routes (identified for the booking request initiated by the passenger 102a) from the route identifier 202b or the memory 204. In an embodiment, the route selector 202c may be configured to select the one or more sponsored routes for the passenger 102a from the first set of sponsored routes based on the persona or the route preferences of the passenger 102a. In another embodiment, the route selector 202c may be configured to select the one or more sponsored routes from the first set of sponsored routes irrespective of the persona of the passenger 102a, such that the one or more sponsored routes may be associated with one or more dynamic advertisements and may be proposed to all passengers or drivers.

Further, in an embodiment, the route selector 202c may be configured to determine route preferences of the drivers, and store the route preferences in the memory 204. The route preferences of the drivers, for example, the driver 108a may be determined based on the persona of the driver 108a. The route selector 202c may be configured to select one or more sponsored routes from the second set of sponsored routes based on the persona or the route preferences of the driver 108a.

In a scenario where the booking request initiated by the passenger 102a is for ride-sharing, the route selector 202c may be configured to determine the first sponsored route for the passenger 102a. The first sponsored route may be determined based on the combined persona of the passengers 102a and 102b. The passenger 102b may be already travelling in the vehicle 106b. In another scenario of the present disclosure, the passenger 102a may be already travelling along the first non-sponsored route. In such scenario, the route selector 202c may be configured to determine a set of sponsored lanes for the passenger 102a. Each sponsored lane may originate from a node on the first non-sponsored route and terminate at another node on the first non-sponsored route, and may be associated with at least one offer. The route selector 202c may be implemented by one or more processors, such as, but are not limited to, an ASIC processor, a RISC processor, a CISC processor, and an FPGA.

The vehicle allocator 202d may include suitable logic, circuitry, interfaces, and/or codes, executable by the circuitry, that may be configured to perform the one or more operations for vehicle allocation using the route preferences. In an embodiment, when the booking request initiated by the passenger 102a is for the non-share ride, the vehicle allocator 202d may be configured to allocate the vehicle 106a to the passenger 102a for the non-share ride based on the route selection performed by the passenger 102a in real-time. For example, the vehicle allocator 202d may allocate the vehicle 106a to the passenger 102a, based on selection of the first sponsored route by the passenger 102a from the one or more sponsored routes and the first set of non-sponsored routes rendered on the first user interface. In another embodiment, when the booking request initiated by the passenger 102a is for the share-ride, the vehicle allocator 202d may be configured to allocate the vehicle 106b to the passenger 102a, when the passenger 102b (who is already travelling in the vehicle 106b) provides consent for travelling along the first sponsored route selected by the passenger 102a. The vehicle allocator 202d may be implemented by one or more processors, such as, but are not limited to, an ASIC processor, a RISC processor, a CISC processor, and an FPGA.

The memory 204 may include suitable logic, circuitry, interfaces, and/or codes, executable by the circuitry, that may be configured to store one or more instructions that are executed by the processor 202, the persona generator 202a, the route identifier 202b, the route selector 202c, and the vehicle allocator 202d to perform their operations. The memory 204 may be configured to temporarily store the historical travel data, the passenger information, or the driver information extracted from the database server 114. The memory 204 may be further configured to temporarily store the booking requests initiated by the one or more passengers such as the passenger 102a. The memory 204 may be further configured to temporarily store the route information and the offer associated with each sponsored route. The memory 204 may be further configured to temporarily store the persona and the route preferences of each passenger and driver. The memory 204 may be further configured to temporarily store the allocation information associated with each vehicle. Examples of the memory 204 include, but are not limited to, a random-access memory (RAM), a read-only memory (ROM), a programmable ROM (PROM), and an erasable PROM (EPROM).

The transceiver 206 may include suitable logic, circuitry, interfaces, and/or codes, executable by the circuitry, that may be configured to transmit (or receive) data to (or from) various servers or devices, such as the passenger devices 104a and 104b, the driver devices 110a and 110b, or the database server 114. Examples of the transceiver 206 may include, but are not limited to, an antenna, a radio frequency transceiver, a wireless transceiver, and a Bluetooth transceiver. The transceiver 206 may be configured to communicate with the passenger devices 104a and 104b, the driver devices 110a and 110b, or the database server 114 using various wired and wireless communication protocols, such as TCP/IP, UDP, LTE communication protocols, or any combination thereof.

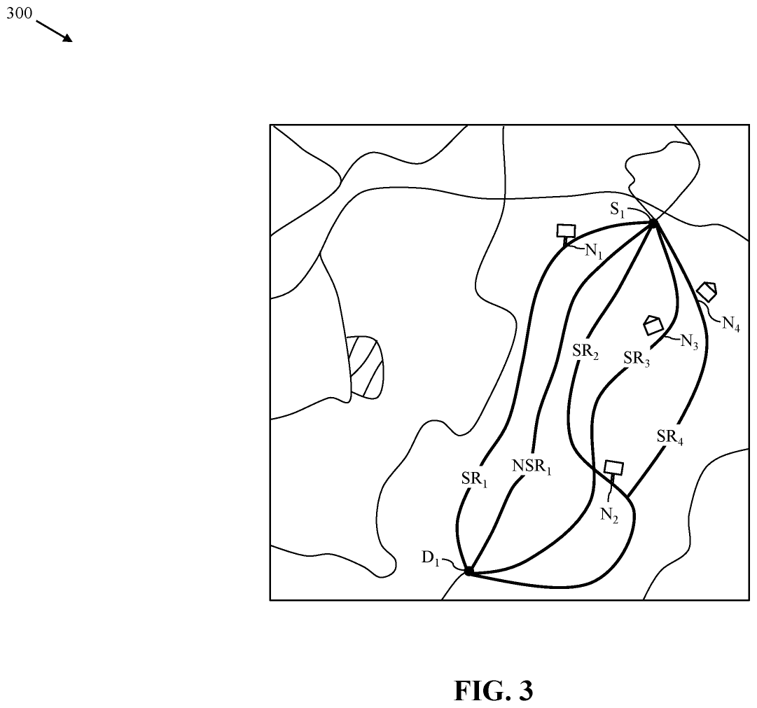

The I/O port 208 may include suitable logic, circuitry, interfaces, and/or codes, executable by the circuitry, that may be configured to perform the one or more operations. The I/O port 208 may include various input and output devices that are configured to communicate with the processor 202. Examples of the input devices may include a keyboard, a mouse, a joystick, a touchscreen, a microphone, and the like. Examples of the output devices may include a display screen, a speaker, headphones, and the like. Various operations of the transportation server 112 along with their advantages and improvements will become apparent in conjunction with FIGS. 3-10.

FIG. 3 is a block diagram that illustrates a road map of a geographical region 300 including sponsored and non-sponsored routes, in accordance with an exemplary embodiment of the disclosure. The road map of the geographical region 300 may include a source location S₁, a destination location D₁, sponsored routes SR₁-SR₄, a non-sponsored route NSR₁, and advertisements or business establishments N₁-N₄. The source location S₁ may be a point of location in the geographical region 300 at which the passenger 102a is currently located. The booking request is initiated, by the passenger 102a, from the source location S₁. The destination location D₁ may be a point of location in the geographical region 300 where the passenger 102a may want to travel from the source location S₁. The destination location D₁ may be specified, by the passenger 102a, while initiating the booking request from the source location S₁. The sponsored routes SR₁-SR₄ may be routes sponsored by one or more sponsors who facilitate one or more offers to the one or more passengers, such as the passenger 102a, for riding through any one of the sponsored routes SR₁-SR₄. The sponsored routes SR₁-SR₄ may originate from the source location S₁ and terminate at the destination location D₁. The non-sponsored route NSR₁ may originate from the source location S₁ and terminate at the destination location D₁ and is independent of any offer. The advertisements or business establishments N₁-N₄ are along the sponsored routes SR₁-SR₄, respectively. Each of the advertisements or business establishments N₁-N₄ may indicate one of a static advertisement, a dynamic advertisement, or a business establishment associated with the one or more sponsors. The static advertisement may be an advertisement of content on a signage board where the advertisement may be changed by manual intervention. The dynamic advertisement may be an advertisement of content on a signage board where the advertisement may be automatically changed or controlled through software solutions. The business establishment may correspond to one of a restaurant, an educational institute, a construction site, or the like.

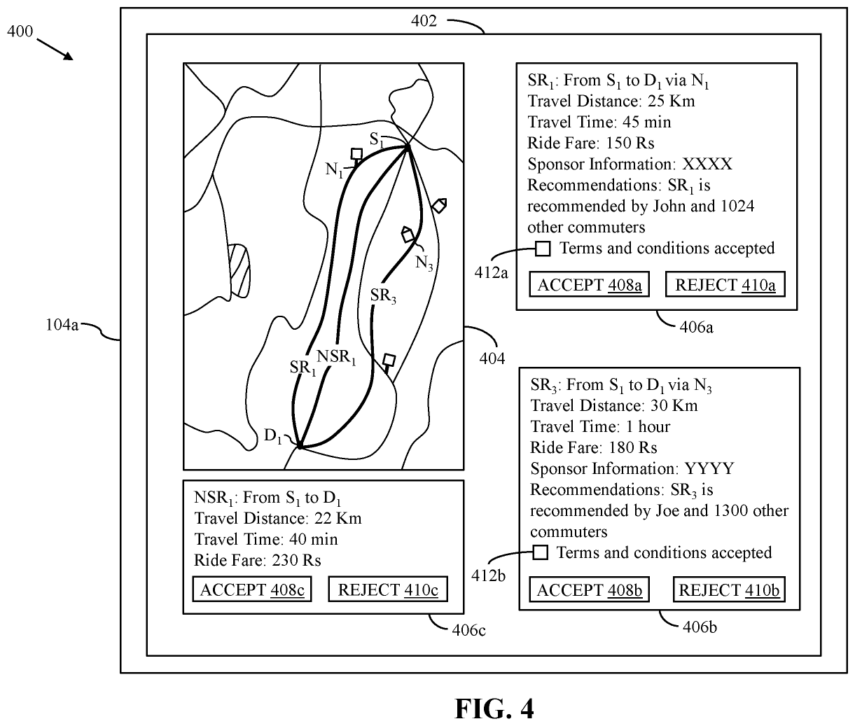

FIG. 4 is a block diagram 400 that illustrates a user interface 402 rendered on the passenger device 104a, in accordance with an exemplary embodiment of the disclosure. The transportation server 112 may be configured to render the user interface 402 (e.g., the first user interface) on the passenger device 104a of the passenger 102a. The user interface 402 may present the one or more sponsored routes and the first set of non-sponsored routes that are selectable by the passenger 102a.

The user interface 402 may include a road map (e.g., a digital road map) of a geographical region 404 and route information 406a-406c. The road map of the geographical region 404 may include the source location S₁, the destination location D₁, the sponsored route SR₁, the sponsored route SR₃, the non-sponsored route NSR₁, and the advertisements or business establishments N₁-N₃. The route information 406a may further include a plurality of options, such as a first option 408a and a second option 410a, and a checkbox 412a. The route information 406a may further include route attributes for the sponsored route SR₁. The route attributes may include at least a travel distance, a travel time, a ride fare, sponsor information, and recommendations. The first option 408a may be an accept option that is selectable by the passenger 102a to accept the sponsored route SR₁ for the ride. The second option 410a may be a reject option that is selectable by the passenger 102a to reject the sponsored route SR₁ for the ride. The checkbox 412a may be an acceptance checkbox that is selectable by the passenger 102a to accept terms and conditions associated with the sponsored route SR₁. The vehicle allocator 202d may be further configured to allocate the vehicle 106a to the passenger 102a for the ride along the sponsored route SR₁ when the first option 408a (i.e., the accept option) and the checkbox 412a (i.e., the acceptance checkbox) is selected by the passenger 102a. Further, the vehicle allocator 202d may not allocate the vehicle 106a to the passenger 102a for the ride along the sponsored route SR₁ when the second option 410a (i.e., the reject option) is selected by the passenger 102a.

The route information 406b may further include a plurality of options such as a first option 408b and a second option 410b, and a checkbox 412b. The route information 406b may further include route attributes for the third sponsored route SR₃₃. The route attributes may include at least a travel distance, a travel time, a ride fare, sponsor information, and recommendations. The first option 408b may be an accept option that is selectable by the passenger 102a to accept the sponsored route SR₃ for the ride. The second option 410b may be a reject option that is selectable by the passenger 102a to reject the sponsored route SR₃ for the ride. The checkbox 412b may be an acceptance checkbox that is selectable by the passenger 102a to accept terms and conditions associated with the sponsored route SR₃. The vehicle allocator 202d may be configured to allocate the vehicle 106a to the passenger 102a for the ride along the sponsored route SR₃ when the first option 408b (i.e., the accept option) and the checkbox 412b (i.e., the acceptance checkbox) is selected by the passenger 102a. Further, the vehicle allocator 202d may not allocate the vehicle 106a to the passenger 102a for the ride along the sponsored route SR₃ when the second option 410b (i.e., the reject option) is selected by the passenger 102a.

The route information 406c may further include a plurality of options such as a first option 408c and a second option 410c. The route information 406c may further include route attributes for the non-sponsored route NSR₁. The route attributes may include at least a travel distance, a travel time, and a ride fare. The first option 408c may be an accept option that is selectable by the passenger 102a to accept the non-sponsored route NSR₁ for the ride. The second option 410c may be a reject option that is selectable by the passenger 102a to reject the non-sponsored route NSR₁ for the ride. The vehicle allocator 202d may be configured to allocate the vehicle 106a to the passenger 102a for the ride along the non-sponsored route NSR₁ when the first option 408c (i.e., the accept option) is selected by the passenger 102a. Further, the vehicle allocator 202d may not allocate the vehicle 106a to the passenger 102a for the ride along the non-sponsored route NSR₁ when the second option 410c (i.e., the reject option) is selected by the passenger 102a. Further, based on the option selected by the passenger 102a, the transportation server 112 may be configured to re-learn the route preferences of the passenger 102a from the historical travel data and the current travel data, and generate a new set of route-related preferences or recommendations for future rides.

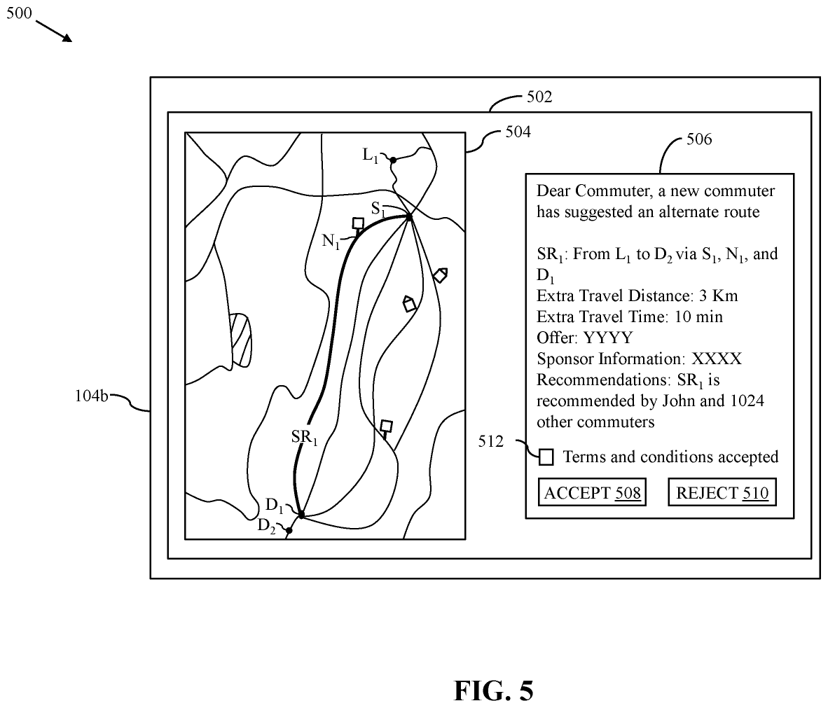

FIG. 5 is a block diagram 500 that illustrates a user interface 502 rendered on the passenger device 104b, in accordance with an exemplary embodiment of the disclosure. The transportation server 112 may be configured to render the user interface 502 on the passenger device 104b of the passenger 102b, when the passenger 102a requests for a share-ride and selects a sponsored route that may be different from a current route along which the passenger 102b is travelling in the vehicle 106b. The user interface 502 may present the sponsored route, selected by the passenger 102a, on the passenger device 104b of the passenger 102b.

The user interface 502 may include a road map (e.g., a digital road map) of a geographical region 504 and route information 506. The road map of the geographical region 504 may further include the source location S₁, the destination location D₁, a location L₁, a location D₂, the sponsored route SR₁, and the advertisement or the business establishment N₁. The location L₁ may be a real-time location of the vehicle 106b in which the passenger 102b is currently travelling. The location D₂ may be a destination location of the passenger 102b. The route information 506 may include a plurality of options, such as a first option 508 and a second option 510, and a checkbox 512. The route information 506 may further include route attributes for the sponsored route SR₁ selected by the passenger 102a for ride-sharing. The route attributes may include at least an extra travel distance, an extra travel time, an offer, sponsor information, and recommendations. The first option 508 may be an accept option that is selectable by the passenger 102b to accept the sponsored route SR₁ for the ride. The second option 510 may be a reject option that is selectable by the passenger 102b to reject the sponsored route SR₁ for the ride. The checkbox 512 may be an acceptance checkbox that is selectable by the passenger 102b to accept terms and conditions associated with the sponsored route SR₁. The vehicle allocator 202d may be configured to allocate the vehicle 106b to the passenger 102a for the share-ride when the first option 508 (i.e., the accept option) and the checkbox 512 (i.e., the acceptance checkbox) is selected by the passenger 102b. Further, the vehicle allocator 202d may not allocate the vehicle 106b to the passenger 102a when the second option 510 (i.e., the reject option) is selected by the passenger 102b. Further, based on the option selected by the passenger 102b, the transportation server 112 may be configured to re-learn the route preferences of the passenger 102b from the historical travel data and the current travel data, and generate a new set of route-related preferences or recommendations for future rides.

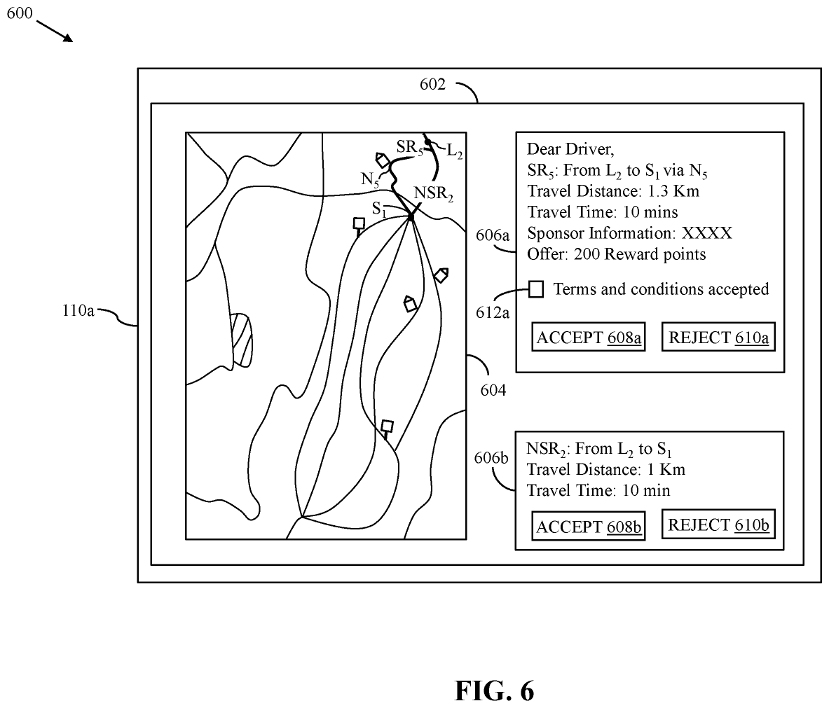

FIG. 6 is a block diagram 600 that illustrates a user interface 602 rendered on the driver device 110a, in accordance with an exemplary embodiment of the disclosure. The transportation server 112 may be configured to render the user interface 602 on the driver device 110a of the driver 108a, when the route selector 202c selects the second set of sponsored routes based on the persona of the driver 108a after allocation of the vehicle 106a to the passenger 102a. The user interface 602 may present the second set of sponsored routes that are selectable by the driver 108a.

The user interface 602 may include a road map (e.g., a digital road map) of a geographical region 604 and route information 606a and 606b. The road map of the geographical region 604 may include the source location S₁, a location L₂, a sponsored route SR₅, a non-sponsored route NSR₂, and an advertisement or a business establishment N₅. The location L₂ may be the current location of the driver 108a of the vehicle 106a. The sponsored route SR₅ and the non-sponsored route NSR₂ may originate from the location L₂ and terminate at the source location S₁. The route information 606a may further include a plurality of options, such as a first option 608a and a second option 610a, and a checkbox 612a. The route information 606a may further include route attributes for the sponsored route SR₅. The route attributes may include at least a travel distance, a travel time, a ride fare, sponsor information, and an offer. The first option 608a may be the accept option that is selectable by the driver 108a to accept the sponsored route SR₅ for the ride. The second option 610a may be the reject option that is selectable by the driver 108a to reject the sponsored route SR₅ for the ride. The checkbox 612a may be the acceptance checkbox that is selectable by the driver 108a to accept terms and conditions associated with the sponsored route SR₅. The transportation server 112 may be configured to allocate the sponsored route SR₅ to the driver 108a when the first option 608a (i.e., the accept option) and the checkbox 612a (i.e., the acceptance checkbox) is selected by the driver 108a. Further, the transportation server 112 may not allocate the sponsored route SR₅ to the driver 108a when the second option 610a (i.e., the reject option) is selected by the driver 108a.

The route information 606b may further include a plurality of options such as a first option 608c and a second option 610c. The route information 606c may further include route attributes for the non-sponsored route NSR₂. The route attributes may include at least a travel distance, a travel time, and a ride fare. The first option 608b may be the accept option that is selectable by the driver 108a to accept the non-sponsored route NSR₂ for the ride. The second option 610b may be the reject option that is selectable by the driver 108a to reject the non-sponsored route NSR₂ for the ride. The transportation server 112 may be configured to allocate the non-sponsored route NSR₂ to the driver 108a when the first option 608c (i.e., the accept option) is selected by the driver 108a. Further, the transportation server 112 may not allocate the second non-sponsored route NSR₂ to the driver 108a when the second option 610c (i.e., the reject option) is selected by the driver 108a. Further, based on the option selected by the driver 108a, the transportation server 112 may be configured to re-learn the route preferences of the driver 108a from the historical travel data and the current travel data, and generate a new set of route-related preferences or recommendations for future rides.

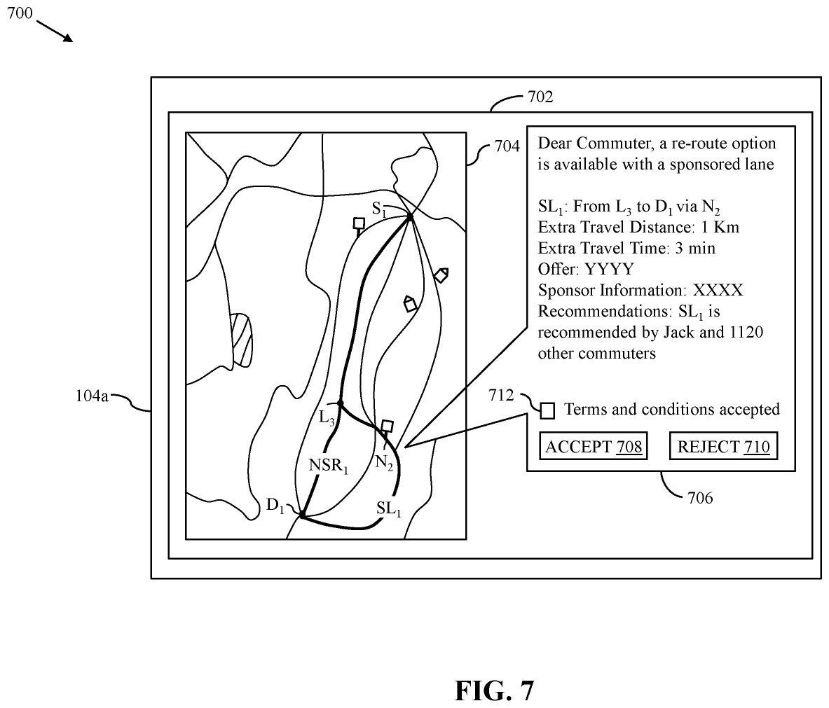

FIG. 7 is a block diagram 700 that illustrates a user interface 702 rendered on the passenger device 104a, in accordance with another exemplary embodiment of the disclosure. The transportation server 112 may be configured to render the user interface 702 on the passenger device 104a of the passenger 102a, when the route selector 202c selects the set of sponsored lanes available for the ride based on the persona of the passenger 102a travelling along the non-sponsored route NSR₁. The user interface 702 may present the set of sponsored lanes that are selectable by the passenger 102a.

The user interface 702 may include a road map (e.g., a digital road map) of a geographical region 704 and a re-route notification 706. The road map of the geographical region 704 may include the source location S₁, the destination location D₁, a location L₃, a sponsored lane SL₁, the non-sponsored route NSR₁, and the advertisement or the business establishment N₂. The location L₃ may be the current location of the passenger 102a who is currently travelling in the vehicle 106a. The sponsored lane SL₁ may be a part of the route that originates from the location L₃ and terminates at the destination location D₁. The re-route notification 706 may include a plurality of options, such as a first option 708 and a second option 710, and a checkbox 712. The re-route notification 706 may further include route attributes for the sponsored lane SL₁. The route attributes may include at least an extra travel distance, an extra travel time, an offer, sponsor information, and recommendations. The first option 708 may be the accept option that is selectable by the passenger 102a to accept a re-route option along the sponsored lane SL₁ for completing the ongoing ride. The second option 710 may be the reject option that is selectable by the passenger 102a to reject the re-route option along the sponsored lane SL₁ and continue to travel along the non-sponsored route NSR₁ for completing the ongoing ride. The checkbox 712 may be the acceptance checkbox that is selectable by the passenger 102a to accept terms and conditions associated with the sponsored lane SL₁. The transportation server 112 may be configured to allocate the sponsored lane SL₁ to the passenger 102a when the first option 708 (i.e., the accept option) and the checkbox 712 (i.e., the acceptance checkbox) is selected by the passenger 102a. Further, the transportation server 112 may not allocate the sponsored lane SL₁ to the passenger 102a when the second option 710 (i.e., the reject option) is selected by the passenger 102a.

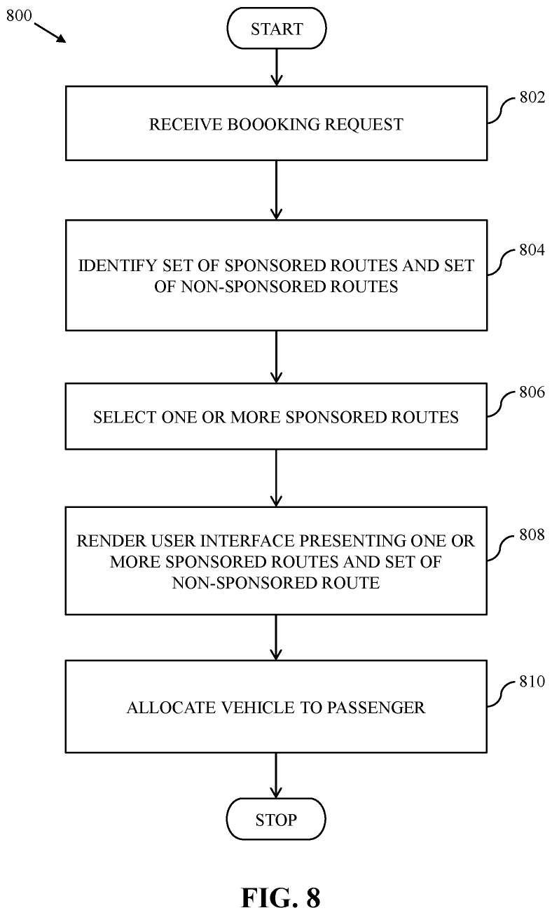

FIG. 8 is a flow chart 800 that illustrates a method for allocating the vehicle 106a to the passenger 102a for the non-share ride, in accordance with an exemplary embodiment of the disclosure.

At 802, the booking request is received. In an embodiment, the transportation server 112 may be configured to receive the booking request from the passenger device 104a of the passenger 102a via the communication network 116. The booking request may include the source location S₁ and the destination location D₁ for the requested ride.

At 804, the first set of sponsored routes and the first set of non-sponsored routes are identified. Based on the booking request, the transportation server 112 may be configured to identify the first set of sponsored routes (such as the sponsored routes SR₁-SR₄) and the first set of non-sponsored routes (such as the non-sponsored route NSR₁). Each identified route may connect the source location S₁ with the destination location D₁.

At 806, the one or more sponsored routes are selected. Based on the persona of the passenger 102a, the transportation server 112 may be configured to select the one or more sponsored routes, such as the sponsored route SR₁ and the sponsored route SR₃, from the first set of sponsored routes (such as the sponsored routes SR₁-SR₄). The persona of the passenger 102a may be generated based on at least one of the historical travel data, the social media profile, the in-vehicle activities during historical rides, or the one or more preferences of the passenger 102a.

At 808, the user interface 402 presenting the one or more sponsored routes and the set of non-sponsored routes is rendered. The transportation server 112 may be configured to render, on the passenger device 104a via the communication network 116, the user interface 402 presenting the one or more sponsored routes (such as the sponsored routes SR₁ and SR₃) and the first set of non-sponsored routes (such as the non-sponsored route NSR₁) that are selectable by the passenger 102a. The user interface 402 may further include the route information 406a-406c, as described above in conjunction with FIG. 4.

At 810, the vehicle 106a is allocated to the passenger 102a. Based on the selection of one of the first sponsored route or the non-sponsored route from the one or more sponsored routes or the first set of non-sponsored routes, respectively, by the passenger 102a, the transportation server 112 may be configured to allocate the available vehicle, such as the vehicle 106a, to the passenger 102a for the request ride. For example, based on the selection of the first option 408a (on the user interface 402) by the passenger 102a, the transportation server 112 may allocate the vehicle 106a to the passenger 102a for travelling along the sponsored route SR₁. Further, the transportation server 112 may be configured to generate the allocation information including at least one of the vehicle information of the vehicle 106a allocated to the passenger 102a, the driver information of the driver 108a of the vehicle 106a, the passenger information of the passenger 102a, the ride fare information associated with the non-share ride, or the real-time position information of the passenger 102a and/or the driver 108a. Thereafter, the transportation server 112 may be configured to transmit the allocation information to the at least one of the passenger device 104a or the driver device 110a. The allocation information may be utilized, by the passenger 102a, to keep a track of the vehicle 106a and timely board the vehicle 106a for the non-share ride. Further, the allocation information may be utilized, by the driver 108a, to reach the source location S₁ of the non-share ride, pick-up the passenger 102a from the source location S₁, and transport the passenger 102a from the source location S₁ to the destination location D₁. The driver 108a may utilize the digital map (hosted by the transportation server 112) to navigate between the locations associated with the non-share ride.

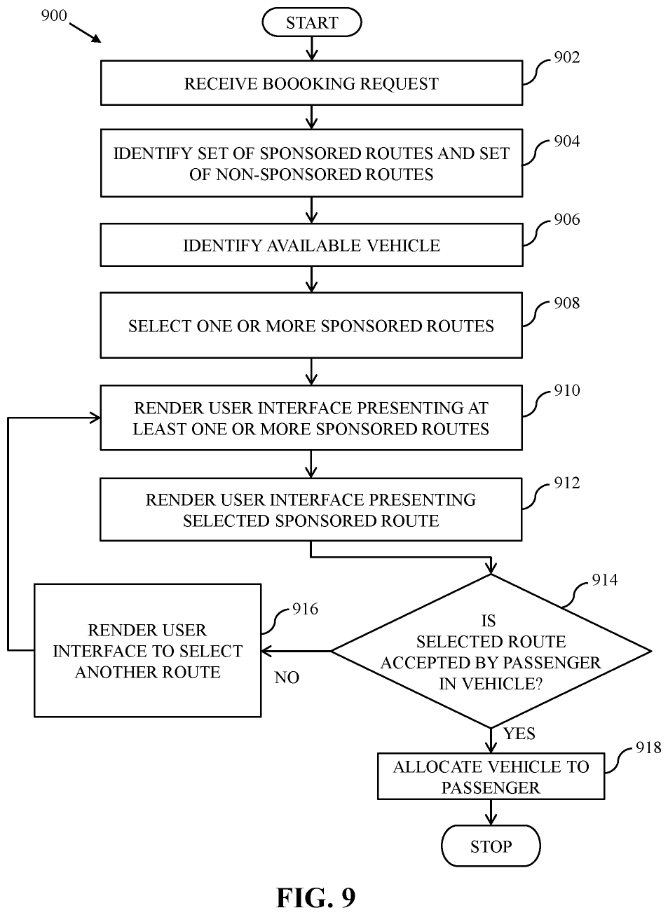

FIG. 9 is a flow chart 900 that illustrates a method for allocating the vehicle 106b to the passenger 102a for the share-ride, in accordance with an exemplary embodiment of the disclosure.

At 902, the booking request is received. In an embodiment, the transportation server 112 may be configured to receive the booking request for the share ride from the passenger device 104a via the communication network 116. The booking request may include at least the source location Si and the destination location D₁.

At 904, the first set of sponsored routes and the first set of non-sponsored routes are identified. Based on the booking request, the transportation server 112 may be configured to identify the first set of sponsored routes (such as the sponsored routes SR₁-SR₄) and the first set of non-sponsored routes (such as the non-sponsored route NSR₁). Each identified route may connect the source location S₁ with the destination location D₁.

At 906, the available vehicle is identified. Based on the booking request, the transportation server 112 may be configured to identify the available vehicle, such as the vehicle 106b, for ride-sharing. In an embodiment, the vehicle 106b may include at least the passenger 102b who is currently riding with the vehicle 106b.

At 908, the one or more sponsored routes are selected. In an embodiment, the transportation server 112 may be configured to select the one or more sponsored routes (such as the sponsored routes SR₁ and SR₃) from the first set of sponsored routes (such as the sponsored routes SR₁-SR₄) based on the combined persona of the passengers 102a and 102b.

At 910, the user interface 402 presenting at least the one or more sponsored routes is rendered. The transportation server 112 may be configured to render, on the passenger device 104a via the communication network 116, the user interface 402 presenting the one or more sponsored routes (such as the sponsored routes SR₁ and SR₃) and the first set of non-sponsored routes (such as the non-sponsored route NSR₁) that are selectable by the passenger 102a. The user interface 402 may further include the route information 406a-406c, as described above in conjunction with FIG. 4. The user interface 402 may be utilized, by the passenger 102a, to select one of the first sponsored route or the non-sponsored route from the one or more sponsored routes (such as the sponsored routes SR₁ and SR₃) and the first set of non-sponsored routes (such as the non-sponsored route NSR₁). For simplicity of the ongoing discussion, the sponsored route SR₁ is selected by the passenger 102a for the share-ride request.

At 912, the user interface 502 presenting the selected sponsored route (such as the sponsored route SR₁) is rendered. The transportation server 112 may be configured to render, on the passenger device 104b via the communication network 116, the user interface 502 presenting the sponsored route information 506 of the sponsored route SR₁ selected by the passenger 102a along with the route attributes associated with the sponsored route SR₁, as described above in conjunction with FIG. 5. The user interface 502 may be utilized, by the passenger 102b, to provide the consent for travelling with the passenger 102a in the vehicle 106b along the selected sponsored route SR₁.

At 914, determine whether the selected sponsored route SR₁ is accepted by the passenger 102b in the vehicle 106b. In an embodiment, the transportation server 112 may be configured to determine whether the selected sponsored route SR₁ is accepted or not accepted by the passenger 102b for travelling via the selected sponsored route SR₁. If at 914, the transportation server 112 determines that the selected sponsored route SR₁ is not accepted by the passenger 102b, then 916 is executed.

At 916, a user interface (not shown) is rendered to select another route. In an embodiment, the transportation server 112 may be configured to render the user interface on the passenger device 104a for notifying the passenger 102a about unacceptance of the selected sponsored route SRI by the passenger 102b, and further prompting the passenger 102a to select another route from the one or more sponsored routes (such as the sponsored routes SR₁ and SR₃) and the first set of non-sponsored routes (such as the non-sponsored route NSR₁) for ride-sharing. To enable the selection of another route by the passenger 102a, 910 is executed. If at 914, the transportation server 112 determines that the selected sponsored route SRI is accepted by the passenger 102b, then 918 is executed.

At 918, the vehicle 106b is allocated to the passenger 102a. Based on the acceptance of the selected sponsored route SR₁ by the passenger 102b for ride-sharing, the transportation server 112 may be configured to allocate the vehicle 106b to the passenger 102a for ride-sharing with the passenger 102b such that the vehicle 106b may be designated to travel via the selected sponsored route SR₁. Further, the transportation server 112 may be configured to generate the allocation information including at least one of the vehicle information of the vehicle 106b allocated to the passenger 102a, the driver information of the driver 108b of the vehicle 106b, the passenger information of the passengers 102a and 102b, the ride fare information associated with the share ride, or the real-time position information of the passengers 102a and 102b, and/or the driver 108b. Thereafter, the transportation server 112 may be configured to transmit the allocation information to the at least one of the passenger device 104a, the passenger device 104b, or the driver device 110b. The allocation information may be utilized, by the passenger 102a, to keep a track of the vehicle 106b and timely board the vehicle 106b for the share ride. Further, the allocation information may be utilized, by the driver 108b, to reach the source location S₁ of the share ride, pick-up the passenger 102a from the source location S₁, and transport the passenger 102a from the source location S₁ to the destination location D₁. The driver 108b may utilize the digital map (hosted by the transportation server 112) to navigate between the locations associated with the share ride.

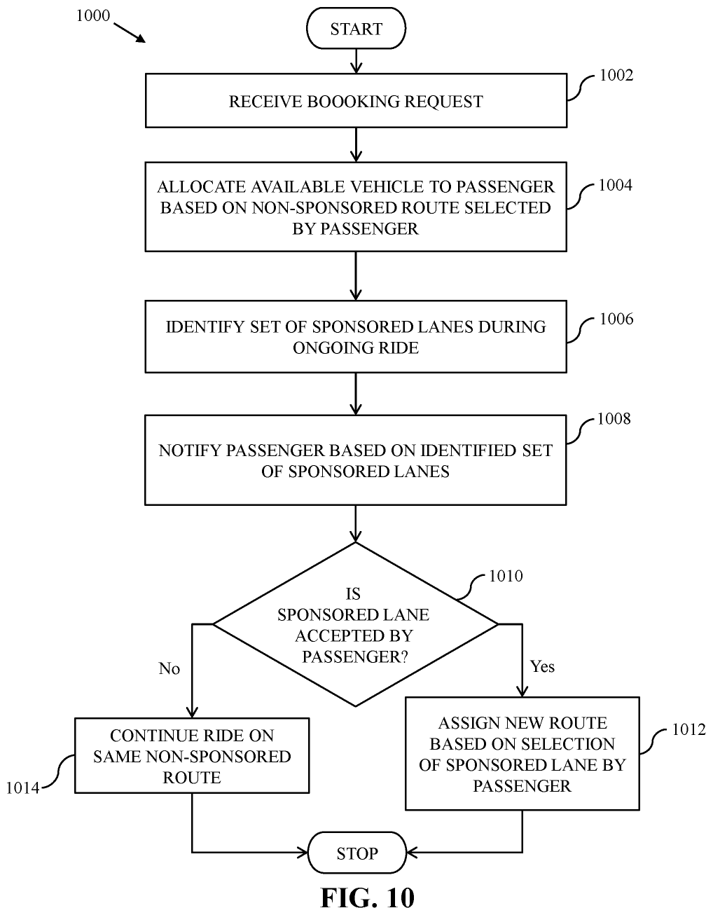

FIG. 10 is a flow chart 1000 that illustrates a method for detouring an ongoing ride, in accordance with an exemplary embodiment of the disclosure.

At 1002, the booking request is received. In an embodiment, the transportation server 112 may be configured to receive the booking request from the passenger device 104a via the communication network 116. The booking request may include at least the source location S₁ and the destination location D₁.

At 1004, the available vehicle is allocated to the passenger 102a based on the non-sponsored route selected by the passenger 102a. The transportation server 112 may be configured to allocate the available vehicle, such as the vehicle 106a, to the passenger 102a based on the non-sponsored route (such as the non-sponsored route NSR₁) selected by the passenger 102a. In one embodiment, the non-sponsored route NSR₁ may be automatically selected, by the transportation server 112 on behalf of the passenger 102a, in absence of any sponsored route and other non-sponsored routes. In another embodiment, the non-sponsored route NSR₁ may be selected, by the passenger 102a, from the first set of non-sponsored routes associated with the booking request, in absence of any sponsored route. In another embodiment, the non-sponsored route NSR₁ may be selected, by the passenger 102a, from the one or more sponsored routes and the first set of non-sponsored routes associated with the booking request. Further, based on the allocation of the vehicle 106a to the passenger 102a, the driver 108a may drive the vehicle 106a via the non-sponsored route NSR₁ to transport the passenger 102a to the destination location D₁.

At 1006, the set of sponsored lanes are identified during the ongoing ride. The transportation server 112 may be configured to identify the set of sponsored lanes (such as the sponsored lane SL₁) based on the persona of the passenger 102a.

At 1008, the passenger 102a is notified based on the identified set of sponsored lanes. In an embodiment, the transportation server 112 may be configured to render, on the passenger device 104a via the communication network 116 during the ongoing ride, the user interface 702 presenting the re-route notification 706 to the passenger 102a who is currently travelling via the non-sponsored route NSR₁. The user interface 702 may be rendered based on the identified set of sponsored lanes. The re-route notification 706 may include the plurality of options, such as the first option 708 and the second option 710, and the checkbox 712. The first option 708 may be the accept option that is selectable by the passenger 102a to accept the re-route option via the sponsored lane SL₁. The second option 710 may be the reject option that is selectable by the passenger 102a to reject the re-route option via the sponsored lane SL₁ and continue along the non-sponsored route NSR₁ for completing the ongoing ride. The checkbox 712 may be the acceptance checkbox that is selectable by the passenger 102a to accept the terms and conditions associated with the sponsored lane SL₁.

At 1010, determine whether the sponsored lane SL₁ is accepted by the passenger 102a. In an embodiment, the transportation server 112 may be configured to determine whether the sponsored lane SL₁ is accepted or not accepted by the passenger 102a for travelling via the sponsored lane SL₁. If at 1010, the transportation server 112 determines that the sponsored lane SL₁ is accepted by the passenger 102a, then 1012 is executed.

At 1012, a new route is assigned based on the selection of the sponsored lane SL₁ by the passenger 102a. The transportation server 112 may be configured to assign the new route for completing the ongoing ride based on the sponsored lane SL₁ selected by the passenger 102a. Further, the transportation server 112 may dynamically update the allocation information, such as at least the route information and the fare information, based on the new route. The driver 108a may drive the vehicle 106a with the passenger 102a via the new route for competing the ongoing ride. If at 1010, the transportation server 112 determines that the sponsored lane SL₁ is not accepted by the passenger 102a, then 1014 is executed.

At 1014, the ongoing ride is continued on the same non-sponsored route. For example, the driver 108a may continue to drive the vehicle 106a with the passenger 102a via the same non-sponsored route NSR₁ for completing the ongoing ride.

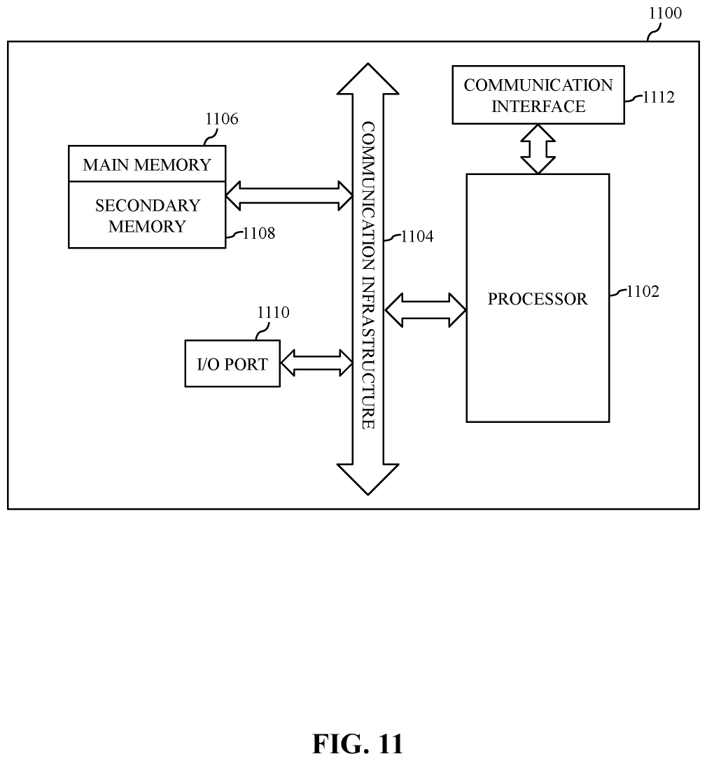

FIG. 11 is a block diagram that illustrates a system architecture of a computer system 1100 for allocating vehicles to passengers, in accordance with an exemplary embodiment of the disclosure. An embodiment of the disclosure, or portions thereof, may be implemented as computer readable code on the computer system 1100. In one example, the transportation server 112 and the database server 114 of FIG. 1 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the vehicle allocation methods of FIGS. 8, 9, and 10.

The computer system 1100 may include a processor 1102 that may be a special purpose or a general-purpose processing device. The processor 1102 may be a single processor, multiple processors, or combinations thereof. The processor 1102 may have one or more processor “cores.” Further, the processor 1102 may be connected to a communication infrastructure 1104, such as a bus, a bridge, a message queue, multi-core message-passing scheme, the communication network 116, or the like. The computer system 1100 may further include a main memory 1106 and a secondary memory 1108. Examples of the main memory 1106 may include RAM, ROM, and the like. The secondary memory 1108 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 1100 may further include an input/output (I/O) port 1110 and a communication interface 1112. The I/O port 1110 may include various input and output devices that are configured to communicate with the processor 1102. Examples of the input devices may include a keyboard, a mouse, a joystick, a touchscreen, a microphone, and the like. Examples of the output devices may include a display screen, a speaker, headphones, and the like. The communication interface 1112 may be configured to allow data to be transferred between the computer system 1100 and various devices that are communicatively coupled to the computer system 1100. Examples of the communication interface 1112 may include a modem, a network interface, i.e., an Ethernet card, a communication port, and the like. Data transferred via the communication interface 1112 may be signals, such as electronic, electromagnetic, optical, or other signals as will be apparent to a person skilled in the art. The signals may travel via a communications channel, such as the communication network 116, which may be configured to transmit the signals to the various devices that are communicatively coupled to the computer system 1100. Examples of the communication channel may include a wired, wireless, and/or optical medium such as cable, fiber optics, a phone line, a cellular phone link, a radio frequency link, and the like. The main memory 1106 and the secondary memory 1108 may refer to non-transitory computer readable mediums that may provide data that enables the computer system 1100 to implement the vehicle allocation methods illustrated in FIGS. 8, 9, and 10.

Various embodiments of the disclosure provide the transportation server 112 for allocating one or more vehicles to one or more passengers. The transportation server 112 may be configured to receive, from the passenger device 104a via the communication network 116, the booking request for the ride between the source location S₁ and the destination location D₁. Based on the booking request, the transportation server 112 may be configured to identify the first set of sponsored routes (such as the sponsored routes SR₁-SR₄) and the first set of non-sponsored routes (such as the non-sponsored route NSR₁). Each sponsored route may originate at least from the source location S₁ and terminate at least at the destination location D₁, and may be associated with at least one offer. Each non-sponsored route may originate at least from the source location S₁ and terminate at least at the destination location D₁, and may be independent of any offer. The transportation server 112 may be configured to select the one or more sponsored routes from the first set of sponsored routes based on the persona of the passenger 102a. The transportation server 112 may be configured to render, on the passenger device 104a via the communication network 116, the user interface 402 presenting the one or more sponsored routes and the first set of non-sponsored routes that are selectable by the passenger 102a. Further, the transportation server 112 may be configured to allocate the vehicle 106a or 106b to the passenger 102a for the ride based on selection of one of the sponsored route SR₁ or the non-sponsored route NSR₁ from the one or more sponsored routes or the first set of non-sponsored routes, respectively, by the passenger 102a by the rendered user interface 402.

Various embodiments of the disclosure provide a non-transitory computer readable medium having stored thereon, computer executable instructions, which when executed by a computer, cause the computer to execute operations for allocating one or more vehicles to one or more passengers. The operations include receiving, by the transportation server 112, from the passenger device 104a via the communication network 116, the booking request for the ride between the source location S₁ and the destination location D₁. The operations further include identifying, by the transportation server 112, the first set of sponsored routes (such as the sponsored routes SR₁-SR₄ ) and the first set of non-sponsored routes (such as the non-sponsored route NSR₁). Each sponsored route may originate at least from the source location S₁ and terminate at least at the destination location D₁, and may be associated with at least one offer. Each non-sponsored route may originate at least from the source location S₁ and terminate at least at the destination location D₁, and may be independent of any offer. The operations further include selecting, by the transportation server 112, the one or more sponsored routes from the first set of sponsored routes based on the persona of the passenger 102a. The operations further include rendering, by the transportation server 112, on the passenger device 104a via the communication network 116, the user interface 402 presenting the one or more sponsored routes and the first set of non-sponsored routes that are selectable by the passenger 102a. The operations further include allocating, by the transportation server 112, the vehicle 106a or 106b to the passenger 102a for the ride based on selection of one of the sponsored route SR₁ or the non-sponsored route NSR₁ from the one or more sponsored routes or the first set of non-sponsored routes, respectively, by the passenger 102a by the rendered user interface 402.

The disclosed embodiments encompass numerous advantages. The disclosure provides various methods and systems for allocating one or more vehicles to one or more passengers using route preferences. The disclosed vehicle allocation methods and systems may facilitate an alternative source for incentivizing the ride based on various offers associated with each sponsored route that may have been sponsored by one or more sponsors. Further, incentivization of the ride may help in optimizing (i.e., reducing) ride fares for shared or non-shared rides that may be availed by the one or more passengers (such as the passengers 102a and 102b). Also, the one or more passengers may have the flexibility to choose between sponsored and non-sponsored routes for shared or non-shared rides as per conveniences. Such flexibility may also be offered to each driver (such as the drivers 108a and 108b) to choose between sponsored and non-sponsored routes. When one or more drivers and passengers are travelling via a sponsored route (such as the sponsored route SR₁), the one or more sponsors of the sponsored route may present or display targeted content (such as the advertisement or business establishment N₁) to the one or more drivers and passengers. The targeted content may be presented or displayed on dynamic or static signage boards. Such presentation or display of the targeted content may help the one or more sponsors to enhance businesses or other establishments along the sponsored route by attracting more and more potential customers in the form of at least the one or more passengers and drivers. Also, various transport service providers (e.g., a cab service provider such as OLA) may enjoy and appreciate an alternative source of income that can boost the overall revenue for the transport service providers. Thus, the transport service providers can continue to provide attractive offers and incentives to the one or more passengers and drivers without compromising on the overall in-vehicle experiences, which in turn may maximize bookings for one-demand cab services.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and methods for allocating vehicles to passengers. While various exemplary embodiments of the disclosed allocating systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method, comprising:
receiving, by a server, from a first passenger device via a communication network, a booking request for a ride between a source location and a destination location;
identifying, by the server, a first set of sponsored routes and a first set of non-sponsored routes for the ride based on the booking request, wherein each sponsored route originates from the source location and terminates at the destination location, and is associated with at least one offer, and wherein each non-sponsored route originates from the source location and terminates at the destination location, and is independent of any offer;
selecting, by the server, one or more sponsored routes from the first set of sponsored routes based on a persona of a first passenger;
rendering, by the server, on the first passenger device via the communication network, a first user interface presenting the one or more sponsored routes and the first set of non-sponsored routes that are selectable by the first passenger; and
allocating, by the server, a vehicle to the first passenger for the ride based on selection of one of a first sponsored route or a first non-sponsored route from the one or more sponsored routes or the first set of non-sponsored routes, respectively, by the first passenger by the rendered user interface, wherein the vehicle is one of a shared vehicle and a non-shared vehicle.

2. The method of claim 1, further comprising generating, by the server, the persona of the first passenger based on at least one of historical travel data, a social media profile, in-vehicle activities during historical rides, or one or more preferences of the first passenger.

3. The method of claim 1, further comprising communicating, by the server, at least one of the persona, one or more preferences, or real-time location of the first passenger to one or more sponsors associated with the first sponsored route, based on selection of the first sponsored route by the first passenger, wherein the offer associated with the first sponsored route is offered by the one or more sponsors.

4. The method of claim 1, further comprising determining, by the server, a second set of sponsored routes for a driver of the vehicle based on a persona of the driver, wherein each sponsored route in the second set of sponsored routes originates from a first location and terminates at the source location, such that the vehicle is at the first location when the server allocates the vehicle to the first passenger.

5. The method of claim 4, further comprising rendering, by the server, on a driver device via the communication network, a second user interface presenting at least the second set of sponsored routes that is selectable by the driver, wherein the driver is incentivized by one or more sponsors associated with a second sponsored route of the second set of sponsored routes, based on selection of the second sponsored route by the driver to reach the source location from the first location.

6. The method of claim 4, wherein each sponsored route in the first and second sets of sponsored routes is associated with at least one of a static advertisement, a dynamic advertisement, or a business establishment associated with one or more sponsors.

7. The method of claim 1, further comprising determining, by the server, a fare for each sponsored route and each non-sponsored route based on at least one of a corresponding distance, a corresponding ride time, a cost per unit distance factor, a cost per unit time factor, or a flat fare factor, wherein the fare for each sponsored route is further determined based on the corresponding offer.

8. The method of claim 1, further comprising communicating, by the server, information pertaining to the first sponsored route selected by the first passenger to at least one second passenger travelling in the shared vehicle before allocation of the shared vehicle to the first passenger, wherein the server communicates the information to the second passenger when a degree of compatibility between a persona of the second passenger and the first sponsored route exceeds a threshold score, and wherein the server allocates the shared vehicle to the first passenger when a consent is provided by the second passenger for travelling along the first sponsored route.

9. The method of claim 1, further comprising rendering, by the server, on the first passenger device, a third user interface presenting a re-route option to the first passenger travelling along the first non-sponsored route in the vehicle, when a part of a route associated with the re-route option is sponsored by one or more sponsors, wherein the first passenger is incentivized by the one or more sponsors in real time, based on selection of the re-route option by the first passenger to reach the destination location.

10. The method of claim 1, wherein the offer is at least one of a flat discount, a distance-based discount, reward points, or a free ride offer.

11. A system, comprising:
circuitry configured to:
receive, from a first passenger device via a communication network, a booking request for a ride between a source location and a destination location;
identify a first set of sponsored routes and a first set of non-sponsored routes for the ride based on the booking request, wherein each sponsored route originates from the source location and terminates at the destination location, and is associated with at least one offer, and wherein each non-sponsored route originates from the source location and terminates at the destination location, and is independent of any offer;
select one or more sponsored routes from the first set of sponsored routes based on a persona of a first passenger;
render, on the first passenger device via the communication network, a first user interface presenting the one or more sponsored routes and the first set of non-sponsored routes that are selectable by the first passenger; and
allocate a vehicle to the first passenger for the ride based on selection of one of a first sponsored route or a first non-sponsored route from the one or more sponsored routes or the first set of non-sponsored routes, respectively, by the first passenger by the rendered user interface, wherein the vehicle is one of a shared vehicle and a non-shared vehicle.

12. The system of claim 11, wherein the circuitry is further configured to generate the persona of the first passenger based on at least one of historical travel data, a social media profile, in-vehicle activities during historical rides, or one or more preferences of the first passenger.

13. The system of claim 11, wherein the circuitry is further configured to communicate at least one of the persona, one or more preferences, or real-time location of the first passenger to one or more sponsors associated with the first sponsored route, based on selection of the first sponsored route by the first passenger, wherein the offer associated with the first sponsored route is offered by the one or more sponsors.

14. The system of claim 11, wherein the circuitry is further configured to determine a second set of sponsored routes for a driver of the vehicle based on a persona of the driver, wherein each sponsored route in the second set of sponsored routes originates from a first location and terminates at the source location, such that the vehicle is at the first location when the server allocates the vehicle to the first passenger.

15. The system of claim 14, wherein the circuitry is further configured to render, on a driver device of the driver via the communication network, a second user interface presenting at least the second set of sponsored routes that is selectable by the driver, wherein the driver is incentivized by one or more sponsors associated with a second sponsored route of the second set of sponsored routes, based on selection of the second sponsored route by the driver to reach the source location from the first location.

16. The system of claim 14, wherein each sponsored route in the first and second sets of sponsored routes is associated with at least one of a static advertisement, a dynamic advertisement, or a business establishment associated with one or more sponsors.

17. The system of claim 11, wherein the circuitry is further configured to determine a fare for each sponsored route and each non-sponsored route based on at least one of a corresponding distance, a corresponding ride time, a cost per unit distance factor, a cost per unit time factor, or a flat fare factor, wherein the fare for each sponsored route is further determined based on the corresponding offer.

18. The system of claim 11, wherein the circuitry is further configured to communicate information pertaining to the first sponsored route selected by the first passenger to at least one second passenger travelling in the shared vehicle before allocation of the shared vehicle to the first passenger, wherein the server communicates the information to the second passenger when a degree of compatibility between a persona of the second passenger and the first sponsored route exceeds a threshold score, and wherein the server allocates the shared vehicle to the first passenger when a consent is provided by the second passenger for travelling along the first sponsored route.

19. The system of claim 11, wherein the circuitry is further configured to render, on the first passenger device, a third user interface presenting a re-route option to the first passenger travelling along the first non-sponsored route in the vehicle, when a part of a route associated with the re-route option is sponsored by one or more sponsors, wherein the first passenger is incentivized by the one or more sponsors in real time, based on selection of the re-route option by the first passenger to reach the destination location.

20. The system of claim 11, wherein the offer is at least one of a flat discount, a distance-based discount, a reward point, or a free ride offer.
